(19) United States
(12) Patent Application Publication
(10) Pub. No.: US 2010/0306046 A1
(43) Pub. Date: Dec. 2, 2010

(54) FAST BUILDING AND MONITORING SYSTEM AND METHOD FOR SEARCH ENGINE MARKETING

(75) Inventors: Charles R. Hentrich, JR., San Francisco, CA (US); Matthew McClure, San Francisco, CA (US)

Correspondence Address: SNR DENTON US LLP, P.O. BOX 061080, WACKER DRIVE STATION, WILLIS TOWER, CHICAGO, IL, 60606-1080, US

(73) Assignee: CLICK GROUP, INC., San Francisco, CA (US)

(21) Appl. No.: 12/476,178

(22) Filed: Jun. 1, 2009

(51) Int. Cl. G06Q 30/00; G06F 17/30

(52) U.S. Cl. 705/14.45; 705/14.72; 705/14.49; 707/E17.108

(57) ABSTRACT

The invention provides a method of providing information over a network, including creating combined information by combining information from a list of product web pages and links to the products with predetermined patterns for keywords, ad titles, and descriptions, and uploading the combined information to the search engine to create the campaign for the links, wherein the web pages are stored at a plurality of web page locations, a search request transmitted from a client location connected over the network to the search engine being utilized at the search engine to extract at least one of the links of the web pages from a search database connected to the search engine, and the search engine transmitting at least one search result link to the client location, the search result link being based on the search request and the search result link being utilized at the client location to transmit a request for the web page over the network such that the web page is transmitted from the web page location to the client location in response to the request from the client location for the web page.

### BACKGROUND TO THE INVENTION

1). Field of the Invention

This invention relates to a method and a system for providing information over a network such as the internet.

2). Discussion of the Related Art

Computer systems can be used for accessing and downloading pages and documents from remote sites over the internet. These remote sites can be accessed by entering a uniform resource locator (URL) in an address box in a browser.

Search engines are often used to find web pages, documents and other content over the internet. A server site crawler regularly collects data from remote sites over the internet, and the data is indexed into a search database. A search engine provider provides an interface with a search box for entering a search query. The search query is transmitted from the search engine site to the server, and is used to parse or extract data from the search database. A search results page is then transmitted from the server to the client site, and lists a plurality of URLs that can be selected by a user to direct the user to selected ones of the remote sites.

### SUMMARY OF THE INVENTION

The invention provides a method of providing information over a network, including creating combined information by combining information from a list of product web pages and links to the products with predetermined patterns for keywords, ad titles, and descriptions, and uploading the combined information to the search engine to create the campaign for the links, wherein the web pages are stored at a plurality of web page locations, a search request transmitted from a client location connected over the network to the search engine being utilized at the search engine to extract at least one of the links of the web pages from a search database connected to the search engine, and the search engine transmitting at least one search result link to the client location, the search result link being based on the search request and the search result link being utilized at the client location to transmit a request for the web page over the network such that the web page is transmitted from the web page location to the client location in response to the request from the client location for the web page.

The method may further include preparing a paid inclusion representation of a web page, and providing the paid inclusion representation to a search engine.

The method may further include extracting a synonym for each of a plurality of keywords, associating each synonym with a respective one of a set of links, and transmitting the synonyms to the search engine for association with the links as a search engine marketing campaign.

The method may further include using a template to combine the information from the list of good products with predetermined patterns for keywords, ad titles, and descriptions.

The combination may be in the form of a spreadsheet that is uploaded to a search engine to create the campaign.

The method may further include periodically retrieving the list of good products and storing any changes.

The method may further include if a listing has been dropped from the list of products, pausing all ad groups pertaining to the listing in the campaign.

For each active ad group, if the ad group has received X number of clicks and has a Return On Ad Spend (ROAS) less than Y, the ad group may be paused in the search engine marketing campaign.

For each active keyword, if the keyword has received X number of clicks and has a Return On Ad Spend (ROAS) less than Y, the keyword may be paused in the search engine marketing campaign.

The method may further include receiving at least one tracking signal indicative of use at the client location of at least some of the web pages in the list, and transmitting a second list of web pages to the search engine, the second list being a subset of web pages, the subset being selected based on the tracking signals.

The invention also provides a computer-readable medium having stored thereon a set of instructions that is executable by a processor of at least one computer to provide information over a network according to a method of providing information over a network, including creating combined information by combining information from a list of product web pages and links to the products with predetermined patterns for keywords, ad titles, and descriptions, and uploading the combined information to the search engine to create the campaign for the links, wherein the web pages are stored at a plurality of web page locations, a search request transmitted from a client location connected over the network to the search engine being utilized at the search engine to extract at least one of the links of the web pages from a search database connected to the search engine, and the search engine transmitting at least one search result link to the client location, the search result link being based on the search request and the search result link being utilized at the client location to transmit a request for the web page over the network such that the web page is transmitted from the web page location to the client location in response to the request from the client location for the web page.

The invention also provides a method of providing information over a network, including storing a plurality of product web pages at a plurality of web page locations, creating combined information by combining information from a list of product web pages and links to the products with predetermined patterns for keywords, ad titles, and descriptions, and uploading the combined information to the search engine to create the campaign for the links, wherein the web pages are stored at a plurality of web page locations, a search request transmitted from a client location connected over the network to the search engine being utilized at the search engine to extract at least one of the links of the web pages from a search database connected to the search engine, and the search engine transmitting at least one search result link to the client location, the search result link being based on the search request and the search result link being utilized at the client location to transmit a request for the web page over the network such that the web page is transmitted from the web page location to the client location in response to the request from the client location for the web page.

The invention also provides a computer system for providing information over a network, including a search engine marketing system which includes a module to create combined information by combining information from a list of product web pages and links to the products with predetermined patterns for keywords, ad titles, and descriptions, and uploading the combined information to the search engine to create the campaign for the links, wherein the web pages are stored at a plurality of web page locations, a search request transmitted from a client location connected over the network to the search engine being utilized at the search engine to extract at least one of the links of the web pages from a search database connected to the search engine, and the search engine transmitting at least one search result link to the client location, the search result link being based on the search request and the search result link being utilized at the client location to transmit a request for the web page over the network such that the web page is transmitted from the web page location to the client location in response to the request from the client location for the web page.

The computer system may further include a paid inclusion system which includes a module to create a representation of a website, a module to store the representation at a representation location, a module to transmit a crawling link to the search engine, the crawling link being utilized by a crawler to access and copy the representation from the representation location to the search database, to provide the representation to a search engine, a feed reader receiving a tracking signal indicative of use at the client location of at least some of the web pages in the list, the feed reader transmitting a second list of web pages to the search engine, the second list being a subset of web pages, the subset being selected based on the tracking signals.

The computer system may further include a keyword builder extracting a synonym for each of a plurality of keywords, a generation module associating each synonym with a respective one of a set of links, and a transmission module transmitting the synonyms to the search engine for association with the links.

The building system may use a template to combine the information from the list of good products with predetermined patterns for keywords, ad titles, and descriptions.

The combination may be in the form of a spreadsheet that is uploaded to a search engine to create the campaign.

The computer system may further include a campaign monitoring system that periodically retrieves the list of good products and stores any changes.

The computer system may further include if a listing has been dropped from the list of products, pausing all ad groups pertaining to the listing in the campaign.

For each active ad group, if the ad group has received X number of clicks and has a Return On Ad Spend (ROAS) less than Y, the ad group may be paused in the search engine marketing campaign.

For each active keyword, if the keyword has received X number of clicks and has a Return On Ad Spend (ROAS) less than Y, the keyword may be paused in the search engine marketing campaign.

### BRIEF DESCRIPTION OF THE DRAWINGS

The invention is further described by way of example with reference to the accompanying drawings wherein:

FIG. 1 is a block diagram of a portion of a system for providing information over a network, in particular illustrating a control system thereof;

FIGS. 2A and 2B are a flowchart showing operation of the system of FIG. 1;

FIG. 3 is an interface of a web page management program forming part of the control system in the view of FIG. 1;

FIG. 4 is a block diagram showing further components of the system for providing information over a network, in particular, showing a search engine server thereof;

FIG. 5 is a block diagram of further components of the control system shown in FIG. 1 that are used for directing a client location based on a predictive future balance of an account;

FIG. 6 is a view of an interface forming part of a client management program shown in FIG. 5;

FIG. 7 is a graph illustrating how an account balance is predicted and remaining days on the account balance are predicted;

FIG. 8 is a block diagram of a keyword or search phrase building system that is used for generating keywords or search phrases for entry in the interface shown in FIG. 3;

FIG. 9 is a block diagram of a computer system that may find application in the system;

FIG. 10 is a block diagram of a paid inclusion system as described with reference to FIGS. 1 to 9 and a keyword discovery system;

FIG. 11 is a block diagram of a smart feed system forming part of the system of FIG. 10;

FIG. 12 is a block diagram of a search engine marketing keyword discovery system for discovery of keywords from paid inclusion keyword data;

FIG. 13 is a screen shot of a keyword discovery system;

FIG. 14 is a block diagram of a fast building and monitoring system; and

FIG. 15 is block diagram of a search engine marketing system, wherein the system of FIG. 14 forms part of the system of FIG. 15.

### DETAILED DESCRIPTION OF THE INVENTION

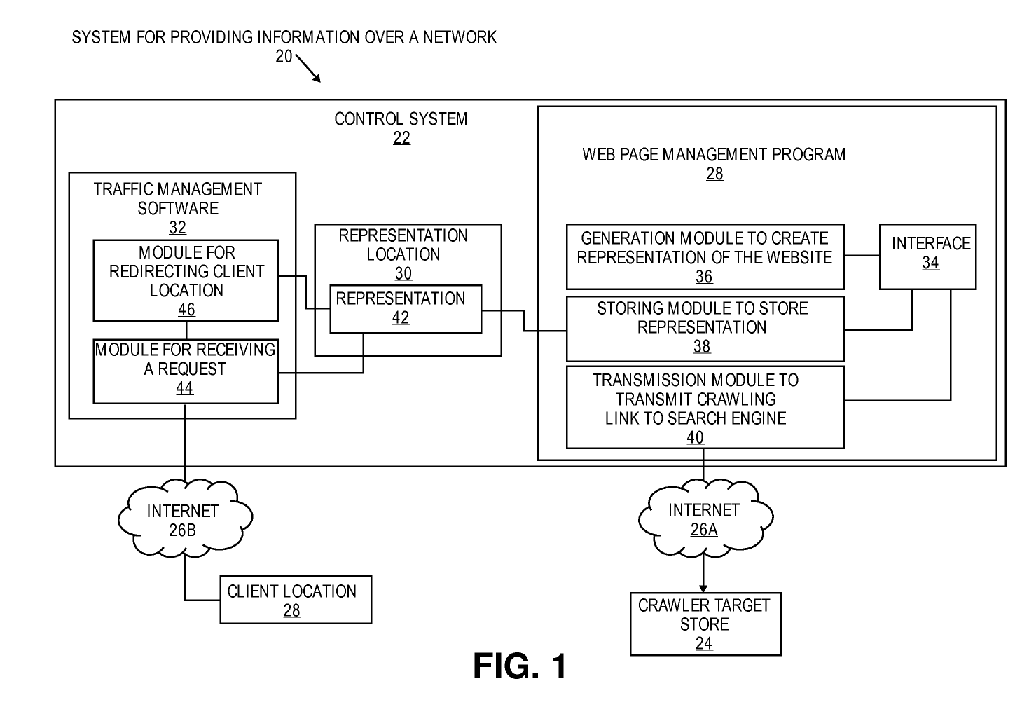

FIG. 1 of the accompanying drawings illustrates a system 20 for providing information over a network, including a control system 22, a crawler target store 24 connected to the control system 22 over a network in the form of the internet 26A, and a client location 28 connected to the control system 22 over the internet 26B.

The control system 22 includes a web page management program 28, a representation location 30 connected to the web page management program 28, and traffic management software 32 connected to the representation location 30. The web page management program 28 includes an interface 34, a generation module 36 to create a representation of a website, a storing module 38 to store a representation, and transmission module 40 to transmit a crawling link to a search engine. The generation module 36, storing module 38, and transmission module 40 are connected to one another. The interface 34 is connected to control functioning of the generation module 36, storing module 38 and transmission module 40.

The representation location 30 is accessible over the internet 26B. One or more representations 42 can be stored by the storing module 38 in the representation location 30.

The traffic management software 32 includes a module 44 for receiving a request and a module 46 for redirecting a client location. The module 44 for receiving the request and the module 46 for directing the client location are both connected to the representation 42 at the representation location 30.

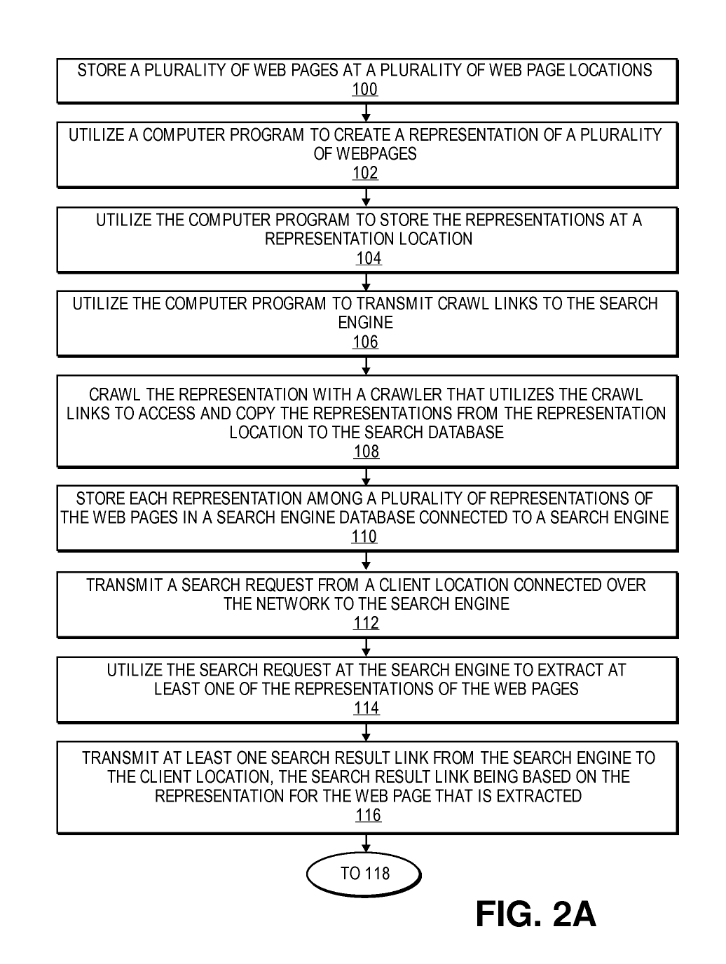

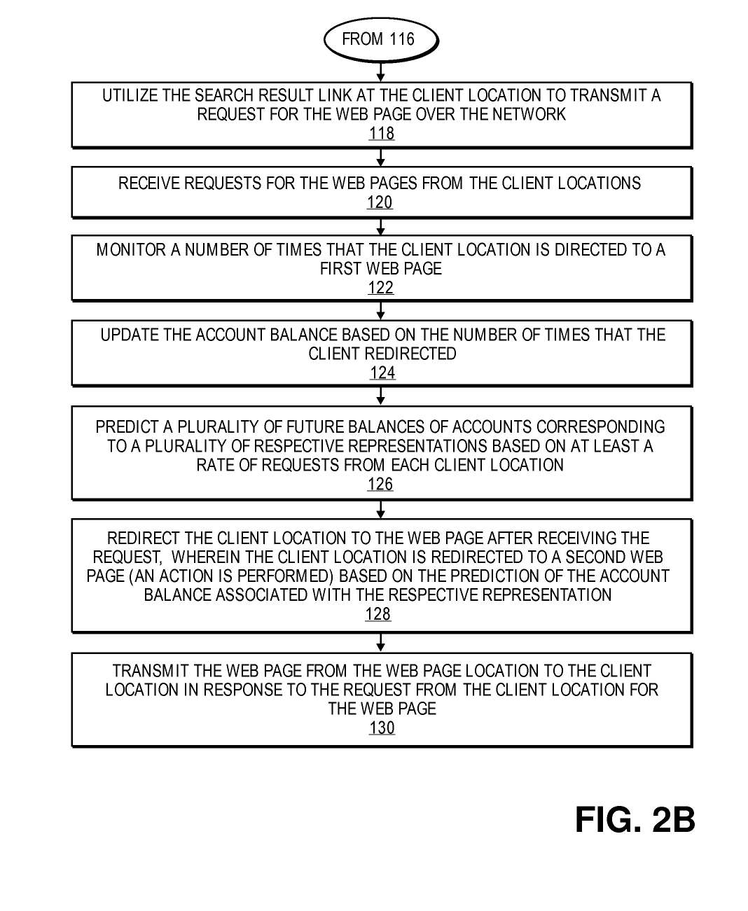

In use, as illustrated in FIG. 2, a plurality of web pages (not shown in FIG. 1) are stored at a plurality of web page locations (not shown) (step 100). The web pages typically include information relating to goods, services or content for sale. The web page management program 28 is a computer program that is utilized to create a representation 42 of each one of the web pages (step 102). The interface 34 and the generation module 36 of the web page management program 28 are used to create the representations 42.

Next, the web page management program 28 is utilized to store the representations 42 at the representation location 30 (step 104). The interface 34 and the storing module 38 are used to store the representations 42 at the representation location 30.

Next, the web page management program 28 is utilized to transmit crawl links to the crawler target store 24 of the search engine (step 106). The interface 34 and the transmission module 40 are used to transmit the crawl links to the search engine.

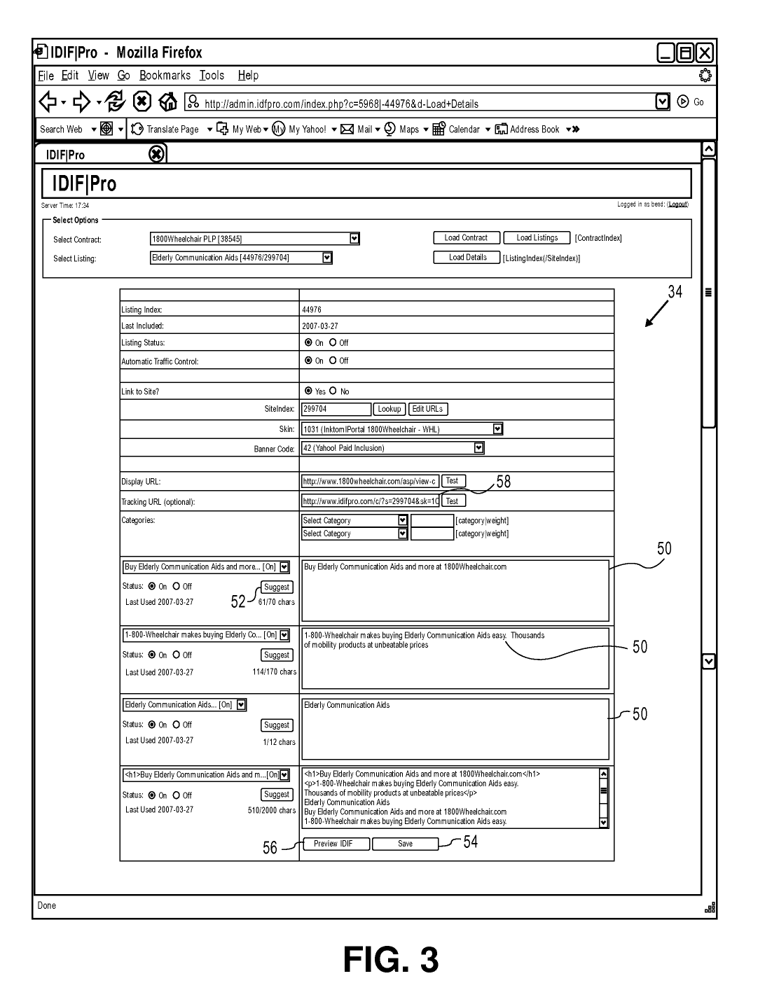

FIG. 3 shows one part of the interface 34 that includes information fields 50 for entering text relating to the website for which the representation is created. The data within the information fields 50 can be entered using a keyboard. Alternatively, the data within the information fields 50 can be generated by selecting a “suggest” button 52 next to and associated with each one of the information fields 50.

A “save” button 54 is provided at the bottom of the interface 34. Upon selection of the save button, the representation 42 in FIG. 1 is automatically generated using the generation module 34 and is automatically stored at the representation location 30 using the storing module 38. A user may alternatively select a “preview” button 56, upon which the representation 42 is automatically created and displayed without storing the representation 42 at the representation location 30.

The interface 34 also has a target link field 58. A URL is associated with the representation 42 located at the representation location 30. The URL of the representation 42 is a target link that is entered in the target link field 58. The target link within the target link field 58 is the target link that is transmitted by the transmission module 40 in FIG. 1 over the internet 26A to the crawler target store. The target link within the target link field 58 can be transmitted upon selection of the “save” button 54. Alternatively, another view of the interface 34 can be used to transmit a plurality of target links, associated with respective representations, over the internet 26A to the crawler target store 24. The interface 34 also has a listing status selector next to the heading “Listing Status.” When the listing status is switched from “On” to “Off”, the representation that will be saved will be blank. The listing status selector allows for an account manager to switch an account “On” to “Off” based on payment or other reasons.

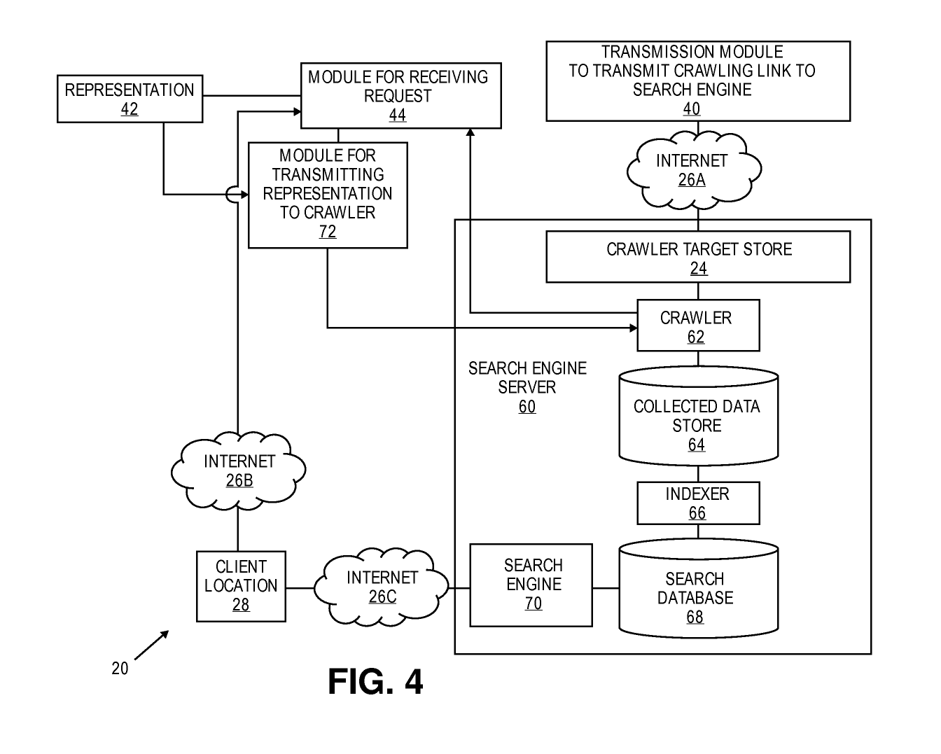

FIG. 4 shows a search engine server system 60 forming part of the system 20 for providing information over a network. The search engine server system 60 includes the crawler target store 24, a crawler 62, a collected data store 64, an indexer 66, a search database 68 and search engine 70 all connected to one another in series. The search engine 70 is connected over the internet 26C to a plurality of client locations 28 (only one of which is shown).

Also shown in FIG. 4 is a module 72 for transmitting a representation to the crawler. The module 72 forms part of the control system 22 shown in FIG. 1. The module 72 is connected between the representation 42 and the crawler 62. The crawler 62 is also connected to the module 44 for receiving a request, shown in FIG. 1.

With further reference to FIGS. 2 and 4, the crawler 62 crawls the representations 42 (step 108). The crawler 62 utilizes the crawl links in the crawler target store 24 to access and copy the representations 42 and then stores the copies in the collected data store 64. The module 44 for receiving a request is a small program with which the crawler 62 can communicate and which is responsible for directing the crawler 62 to the representation 42. The module 72 for transmitting a representation to the crawler is also a small program that transmits the representation 42 to the crawler 62.

A plurality of representations, such as the representation 42, is stored in the collected data store 64. The indexer 66 indexes the representations 42 into a searchable form and stores the indexed representations in the search database 68. The representation 42 is thus stored among a plurality of representations of web pages in the search database 68 connected to the search engine 70 (step 110).

In use, a client at the client location 28 transmits a search request from the client location 28 over the internet 26 to the search engine 70 (step 112). The search engine 70 then utilizes the search request to extract at least one of the representations of the web pages from the search database 68 (step 114). The search engine 70 then extracts a search result link from the representation that is extracted from the search database 68. The search engine 70 then transmits the (at least one) search result link from the search engine 70 over the internet 26C to the client location (step 116). The search result link is based on the representation of the web page that is extracted.

In the present example, the client at the client location 28 will access an interface of the search engine by transmitting the following URL:

http://search.yahoo.com/

The client at the client location 28 then enters a search criteria or a search string in the present example “wheelchair”, and transmits the search request from the client location 28 over the internet 26C to the search engine 70. The search engine 70 then transmits a web page over the internet 26C to the client location 28, the web page having the following address:

http://search.yahoo.com/search;_ylt=
A0geu8EetDdGc3gBz0JXNyoA?p=
1800wheelchair&ei=UTF-8&fr=sfp&x=wrt

The web page that is transmitted to the client location 28 includes a plurality of search results, one of which being for “1800 wheelchair”.

A client at the client location 28 then utilizes the search result link for “1800 wheelchair” to transmit a request for the web page over the internet 26B (step 118). The selection by the client at the client location 28 of the search result for “1800 wheelchair” directs the client location through the module 44 for receiving a request to the representation 42. The client location 28 may not be directed directly to the module 44 and may pass through an intermediate system forming part of the search engine server system 60, represented by the following address:

http://rds.yahoo.com/_ylt=A0geu8cktDdGOxwB4zdXNyoA;_ylu=
X3oDMTE2NTBlOTE4BGNvbG8DZQRsA1dTMQRwb3MDMQRzZWMDc3IEdnRpZANGNjY1Xzgz/SIG=
1ae048b8j/EXP=1178142116/**http%3a//rdre1.yahoo.com/click%3fu=
http%3a//www.idifpro.com/c/%253Fs%253D197940%2526sk%253D1031%2526b%253D42%26y=
04E26DDE0C33D70BC6%26i=482%26c=35614%26q=
02%255ESSHPM%255BL7.%2527//hwzzs%257Cw~vm6%26e=
utf8%26r=0%26d=wow~F665-en-us%26n=0274K1NILCRKC0K3%26s=
11%26t=%26m=4637B425%26x=058F8A6D3CC4FE5C3A3B251EEC7ACF3007

The string above includes the address for the module for redirecting client location 46, namely:

http://www.idifpro.com/c/?s=197940&sk=1031&b=42

The intermediate system forming part of the search engine server system 60 directs the client location 28 to the module 44, which receives the request for the web page from the client location 28 (step 120).

The module for redirecting client location 46 then redirects the client location to the web page corresponding to the parameters in the address for the module for redirecting client location 46, namely

http://www.1800wheelchair.com/?s_cid=wl_{—}0000001

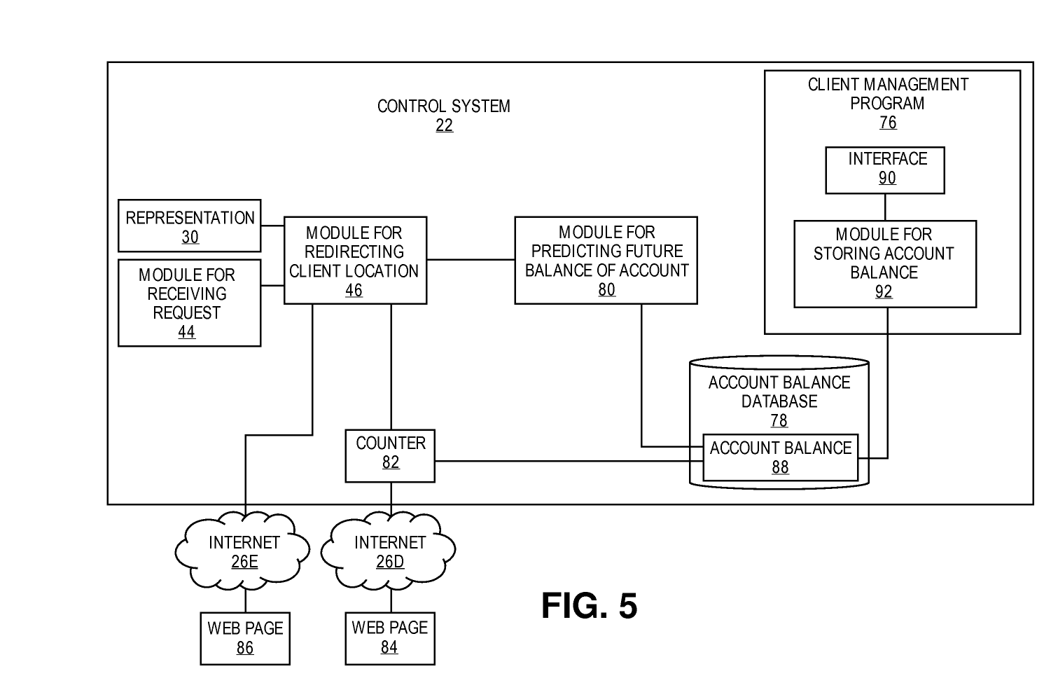

FIG. 5 illustrates further components of the control system 22 shown in FIG. 1, including a client management program 76, an account balance database 78, a module 80 for predicting a future balance of an account, and a counter 82. Also shown in FIG. 5 are first and second web pages 84 and 86, which are typically managed by the same website operator. The web page 84 is typically the web page for which the representation 30 is created.

The account balance database 78 includes a plurality of account databases 88 (only one of which is shown). The client management program 76 includes an interface 90 and a module 92 for storing an account balance. The interface 90 is connected to the module 92 for storing an account balance. The module 92 for storing an account balance is connected to the account balance database 78 for purposes of storing the account balance 88. The account balance 88 is one of multiple account balances that are stored in the account balance database 78. Each account balance stored in the account balance database 78 is associated with a respective one of a plurality of representations such as the representation 30 and a plurality of web pages such as the web page 84.

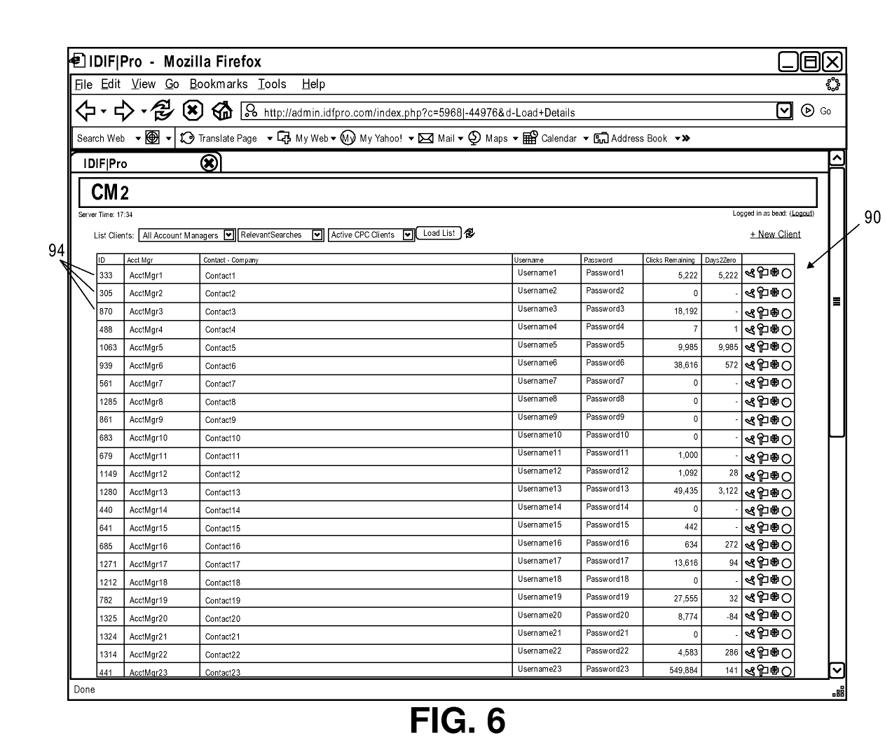

FIG. 6 illustrates the interface 90 of the client management program 76 in FIG. 5. As shown in the interface 90, a plurality of accounts 94 are stored in the client management program 76. Each account 94 shows a respective balance under the heading “Clicks Remaining”. An account manager can select respective ones of the accounts 94 and update the account balance based on recent payment history. Referring again to FIG. 5, the module 92 for storing the account balance then stores the respective account balance 88 entered by the account manager in the account balance database 78.

The module 80 for predicting a future balance of an account is connected to each account balance 88 in the account balance database 78. The module 46 for redirecting a client location is connected to the module 80 for predicting a future balance of an account. The module 46 for redirecting a client location is connected to through the counter 82 and the internet 26D to the web page 84. The module 46 for redirecting a client location is also connected through the internet 26E to the web page 86

With reference to FIGS. 2 and 5, the control system 22 monitors a number of times that a client location 28 (FIGS. 1 and 4) is directed to the web page 84 (step 122). The module 46 for redirecting a client location receives the web page request previously submitted by the client location 28 from the module 44 for receiving requests. The module 46 for redirecting a client location then extracts the address of the web page 84 from the representation 30. In the present example, the address of the web page 84 is:

http://www.1800wheelchair.com/?s_cid=wl_{—}0000001

The module 46 for redirecting a client location then directs the client location through the counter 82 and the internet 26D to the web page 84. When traffic is directed through the counter 82, the counter updates the account balance 88 associated with the representation 30 (step 124). Other account balances within the account balance database 78 remain unchanged. As a result, the number of clicks remaining in a respective account in the interface 90 is reduced by one.

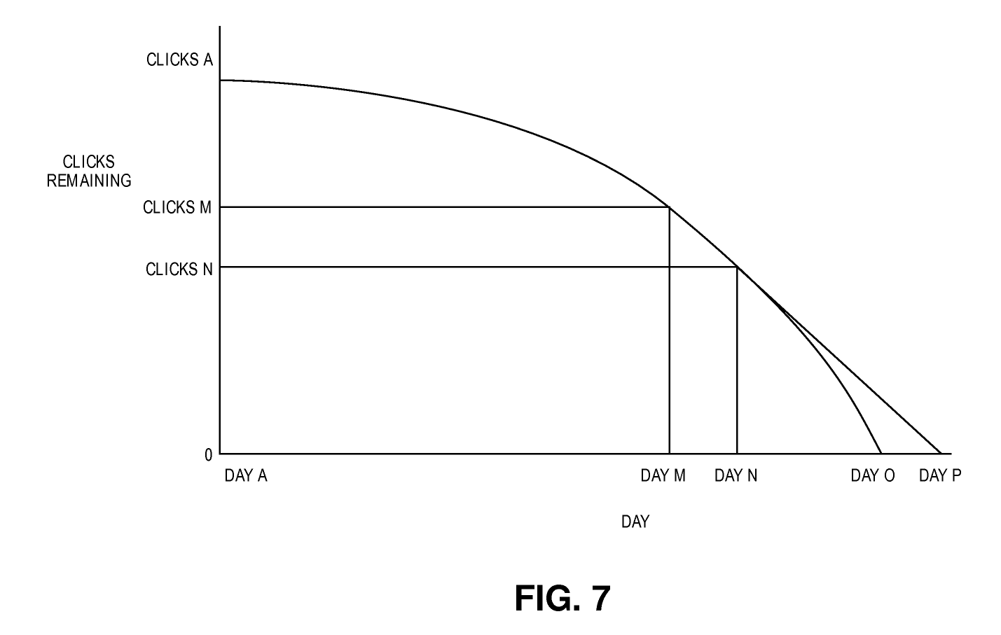

The module 80 for predicting a future balance of an account predicts the balance as shown in FIG. 7. The number of clicks remaining in an account reduces from clicks A to clicks M, clicks N and zero on day A, day M, day N, and day O respectively. On any particular day, the number of clicks remaining is linearized. For example, on day N, a future day P is predicted when the number of clicks will be zero. The future date P is calculated by first calculating a slope, or a usage rate, of clicks between day M and day N and providing for the fact that clicks N are still remaining on day N. Other numerical methods can be employed to predict a future balance and when the balance will be zero.

In a similar manner, a plurality of future balances of accounts corresponding to a plurality of respective representations are predicted based on at least a rate of requests from each client location (step 126). The module 80 for predicting future balances of accounts provides the remaining days of each account to the module 46 for redirecting a client location.

The module 46 for redirecting a client location redirects the client location to the web page 84 after receiving the request from the module 44 for receiving requests. The client location is redirected to the web page 86 (and action is performed) based on the prediction of the account balance associated with the respective representation 30 (step 128). More specifically, if the remaining number of days between day P and day N in FIG. 7 is less than a predetermined number of days, typically less than three days, the client location is not directed to the web page 84 and is instead directed to the web page 86. Depending on which web page 84 or 86 the client location is directed to, the respective web page 84 or 86 is then transmitted from a web page location where the respective web page 84 or 86 is located to the client location 28 (step 130). The addresses for the web pages 84 and 86 are entered using a window (not shown) of the interface 34 in FIG. 3.

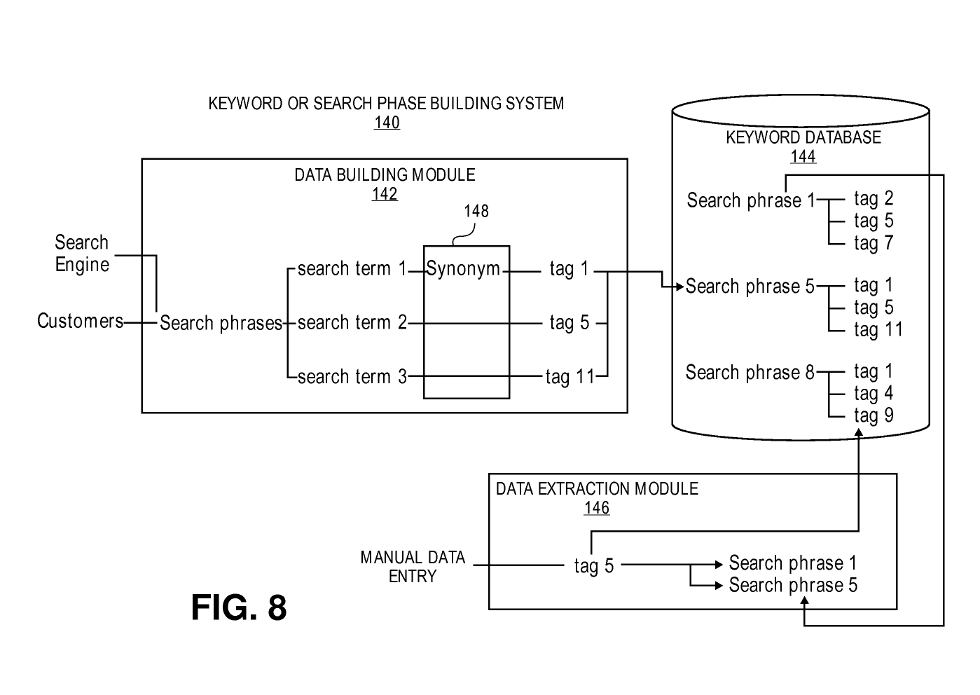

FIG. 8 illustrates a keyword or a search phrase building system 140 that is used to generate keywords or search phrases that are entered in the fields 50 of the interface 34 in FIG. 3. The keyword or search phase building system 140 includes a data building module 142, a keyword database 144, and a data extraction module 146.

The data building module 142 receives input search phrases (search phrase 5) from various sources such as search engines or from customers. The data building module 142 separates each search phrase into a plurality of search terms (search term 1, search term 2 and search term 3). The data building module 142 has a synonym generating engine 148. The synonym generating engine 148 generates a synonym or tag (tag 1, tag 2, and tag 11) corresponding to each one of the search terms. The search phrase (search phrase 5) and the tags (tag 1, tag 5, and tag 11) are then stored in the search database 144 with the tags being associated with the search phrase.

In a similar manner, a plurality of search phrases (search phrase 1, search phrase 5 and search phrase 8) are stored in the keyword database 144 with a respective set of tags associated with each one of the search phrases.

An operator can get a general impression of a web page for which a representation has to be prepared. Manual data entry is used to enter a tag (tag 5) in the data extraction module 146. The tag that is entered into the data extraction module 146 will be representative of the web page for which the representation has to be prepared. It is possible to enter more than one tag into the data extraction module 146. The data extraction module 146 then performs a reverse lookup in the keyword database 144. All the search phrases and only the search phrases having the tag that is entered in the data extraction module 146 associated therewith are extracted. In the present example, search phrase 1 and search phrase 5 have tag 5 associated therewith. Search phrase 1 and search phrase 5 are entered into one of the information fields 50 of the user interface 34 in FIG. 3.

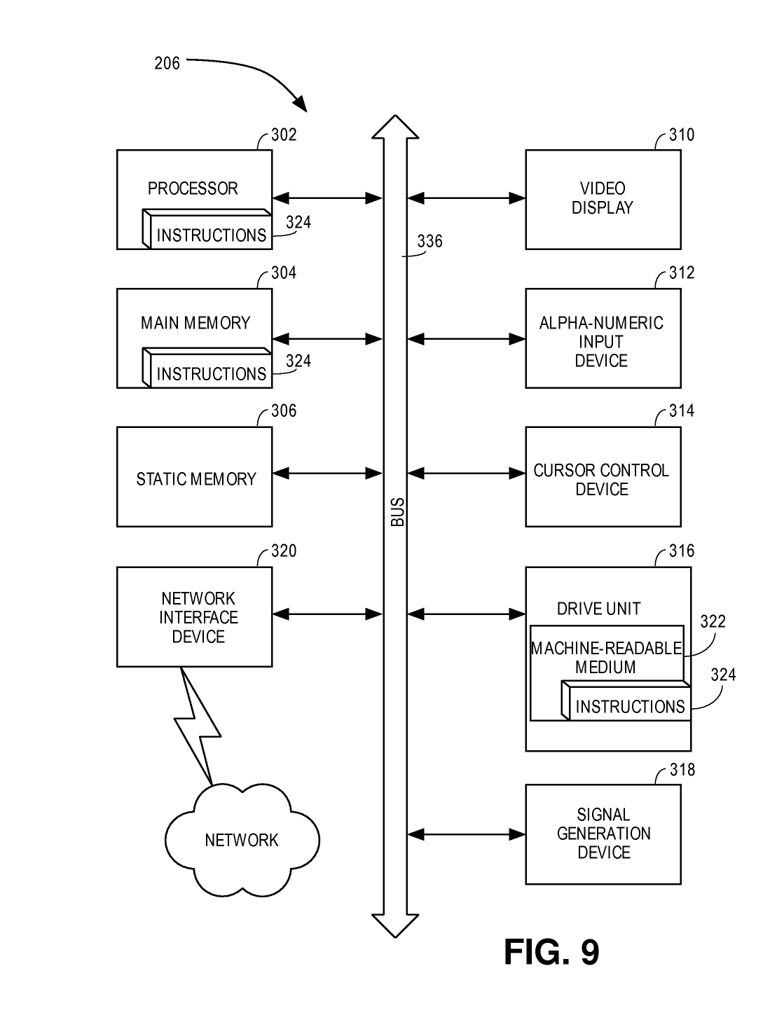

FIG. 9 shows a diagrammatic representation of a machine in the exemplary form of a computer 206 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary client computer 206 includes a processor 302 (e.g., a central processing unit (CPU), a graphics processing unit (CPU), or both), a main memory 304 (e.g., read-only memory (ROM), flash memory, dynamic random access memory (DRAM) such as synchronous DRAM (SDRAM) or Rambus DRAM (RDRAM), etc.), and a static memory 334 (e.g., flash memory, static random access memory (SRAM), etc.), which communicate with each other via a bus 336.

The client computer 206 may further include a video display 310 (e.g., a liquid crystal display (LCD) or a cathode ray tube (CRT)). The client computer 206 also includes an alpha-numeric input device 312 (e.g., a keyboard), a cursor control device 314 (e.g., a mouse), a disk drive unit 316, a signal generation device 318 (e.g., a speaker), and a network interface device 320.

The disk drive unit 316 includes a machine-readable medium 322 on which is stored one or more sets of instructions 324 (e.g., software) embodying any one or more of the methodologies or functions described herein. The software may also reside, completely or at least partially, within the main memory 304 and/or within the processor 302 during execution thereof by the client computer 206, the main memory 304 and the processor 302 also constituting machine-readable media. The software may further be transmitted or received over a network via the network interface device 320.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, and optical and magnetic media.

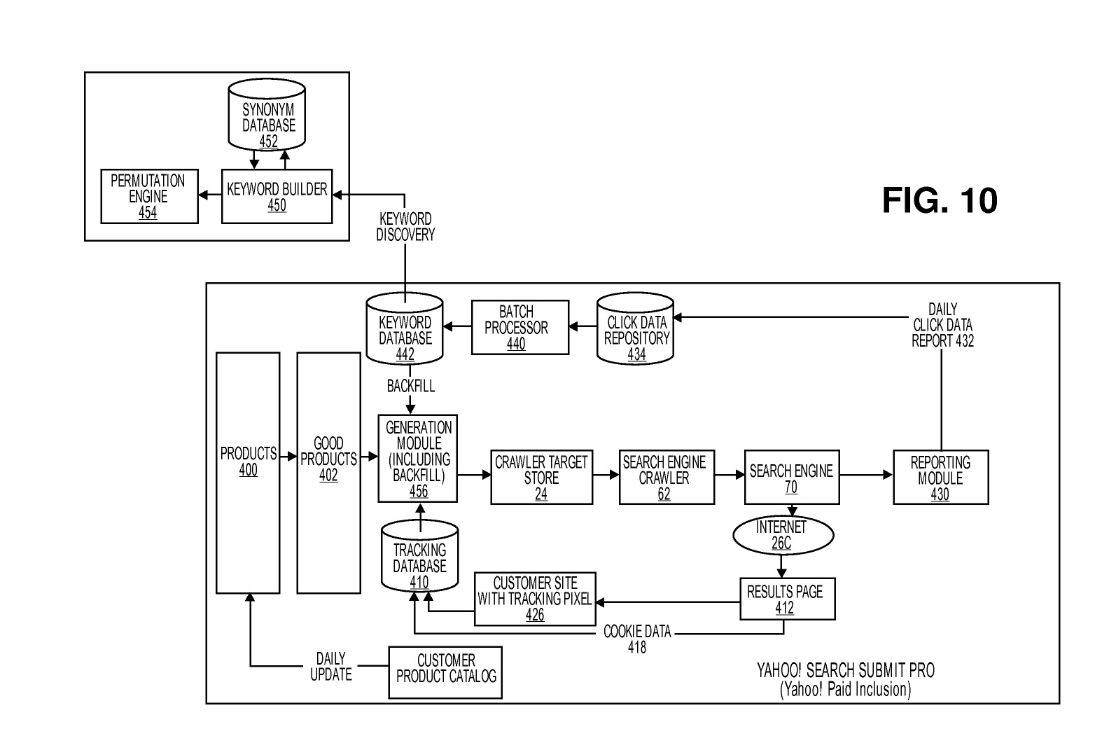

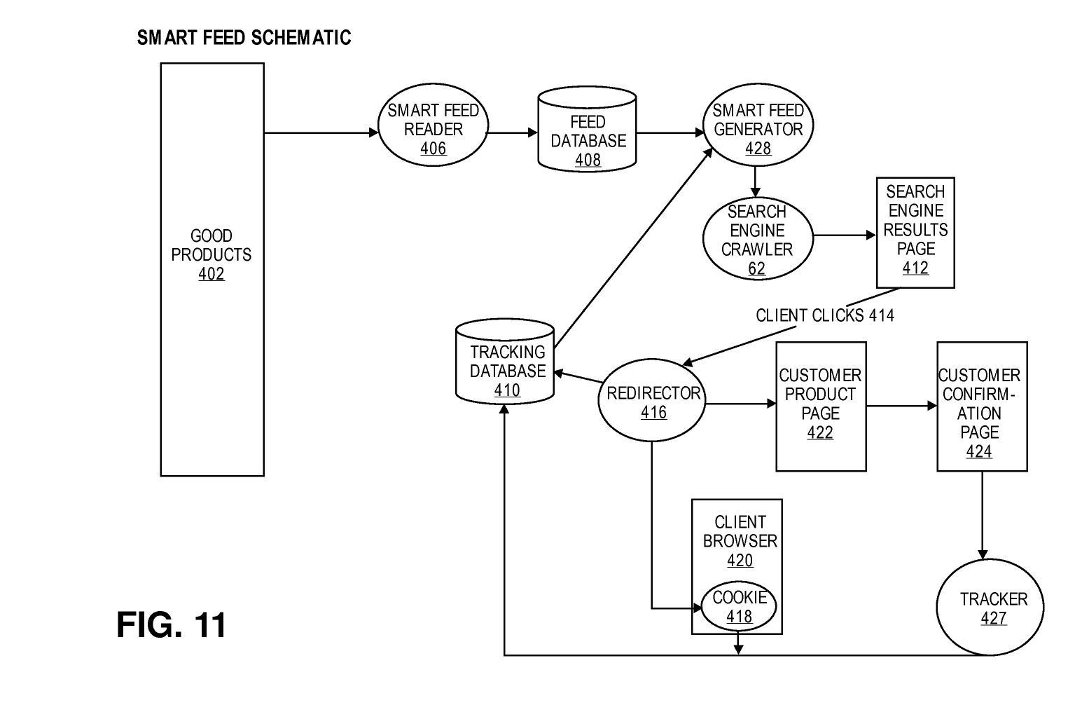

FIGS. 10 and 11 illustrate components of the system of FIGS. 1 to 9 and its integration with a paid inclusion search system such as Yahoo! Search Submit Pro. A customer has a list of products 400 and selects a list of good products 402 that they make available on a web server. A smart feed reader 406 retrieves the list of products 402 each day and stores the result in the feed database 408.

The smart feed generator 428 reads the feed database 408 each day to get that day's active listings, along with any price changes that the customer may have made. For each active listing the smart feed generator 428 looks in a tracking database 410 to see what the performance of that listing has been. If the listing has received X number of clicks and has a Return On Ad Spend (ROAS) less than Y, the listing is not included in the feed provided to the search engine crawler 62.

The search engine crawler 62 reads the feed that the smart feed generator 428 has provided and incorporates the feed data into its algorithm to provide a search engine results page 412 to the client when the client types in a certain query.

When the client clicks 414 on one of the listings in the results page, the click is passed on to a redirector 416, which drops a cookie 418 in the client's browser 420 and redirects the browser to a customer product page 422. The redirector 416 also stores the query the client typed in, the date and time, and the cookie ID in the tracking database 410.

When the client checks out, a customer confirmation page 424 that resides with the customer product page 422 on a customer site 426 (See FIG. 10) has a tracker 427 comprising a tracking pixel that automatically executes a script (typically JavaScript) that reads the client's cookie 418 and passes the amount of the order and the cookie ID to the tracking database 410. The conversion date and time and the amount are then stored in the tracking database 410.

The smart feed generator 428 thus receives a tracking signal from the tracking database 410 indicative of use at the client location of at least some of the web pages in the list of good products 402. A number of tracking signals are received for a number of the list of good products 402. The smart feed generator 428 then transmits a second list of web pages to the search engine, the second list being a subset of web pages, the subset being selected based on the tracking signals.

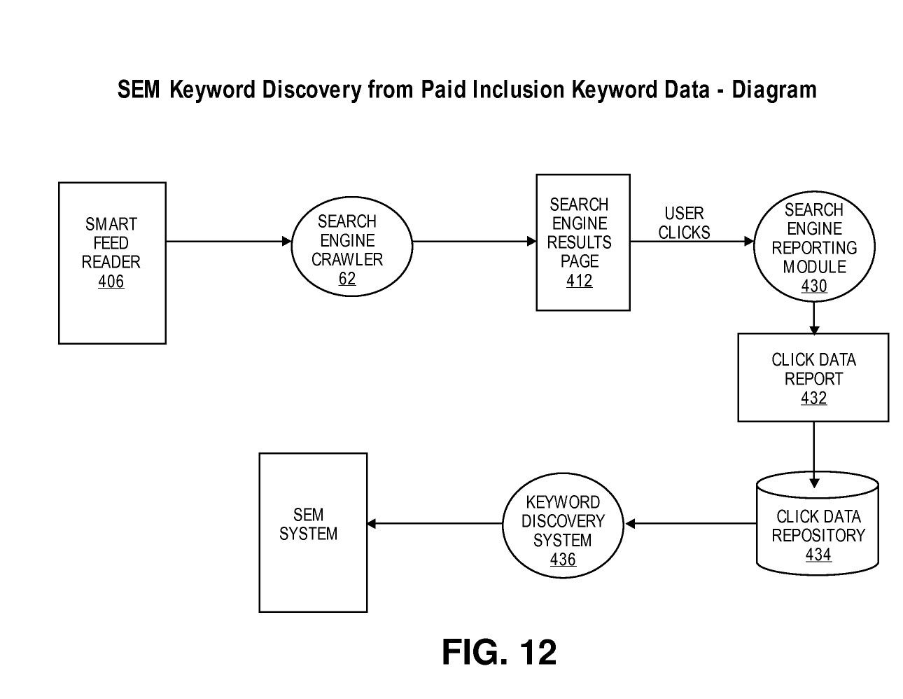

FIGS. 10 and 12 illustrate a search engine marketing keyword discovery system from paid inclusion keyword data. As mentioned with respect to FIG. 11, the smart feed generator 428 prepares a paid inclusion feed that is read by the search engine crawler 62 and the search engine crawler 62 uses the feed to generate a results page 412 in response to a query the client types in.

The client clicks on a listing in the results page and a search engine reporting module 430 records the query the client typed in, the date, and the position of the listing in the results page 412. The reporting module 430 transmits a daily click data report 432 that is stored it in a click data repository 434.

To build a search engine marketing campaign for a listing, a keyword discovery system 436 looks in the click data repository 434 of the paid inclusion subsystem of FIG. 10 to find all the queries that generated a click for that listing. The words from the queries that generated a click for that listing are then combined into all possible three-word combinations.

The combinations are then used as the keywords for the search engine marketing campaign. This gives the system a high probability of having keywords in the campaign that are extremely relevant to the listing, which yields a better Click-Through-Rate and a higher Quality Score.

The paid inclusion system of FIG. 10 includes the click data repository 434 receiving the click data report 432 from the search engine 70 receiving the paid inclusion representation. The keyword discovery system 436 in FIG. 12 utilizes the click data report 432 to determine keywords. As more specifically shown in FIG. 10, the keyword discovery system 436 in FIG. 12 includes a batch processor 440 batch processing the data in the click data repository 434, and a keyword database 442 that stores the data after being batch processed.

As mentioned with respect to the paid inclusion system in FIG. 10, a paid inclusion feed is prepared/built that the search engine crawler 62 reads and uses to generate a search engine results page 412 in response to a query the client types in. The client clicks on a listing in the results page 412 and the reporting module 430 records the query that the client typed in, the date, and the position of the listing in the results page. Each day, a click data report is received from the reporting module 430 and is stored in the click data repository 434.

In order to build a search engine marketing campaign for a listing, the keyword discovery system 436 looks in the click data repository 434 to find all the queries that generated a click for that listing. The words from those queries are then combined into all possible three-word combinations.

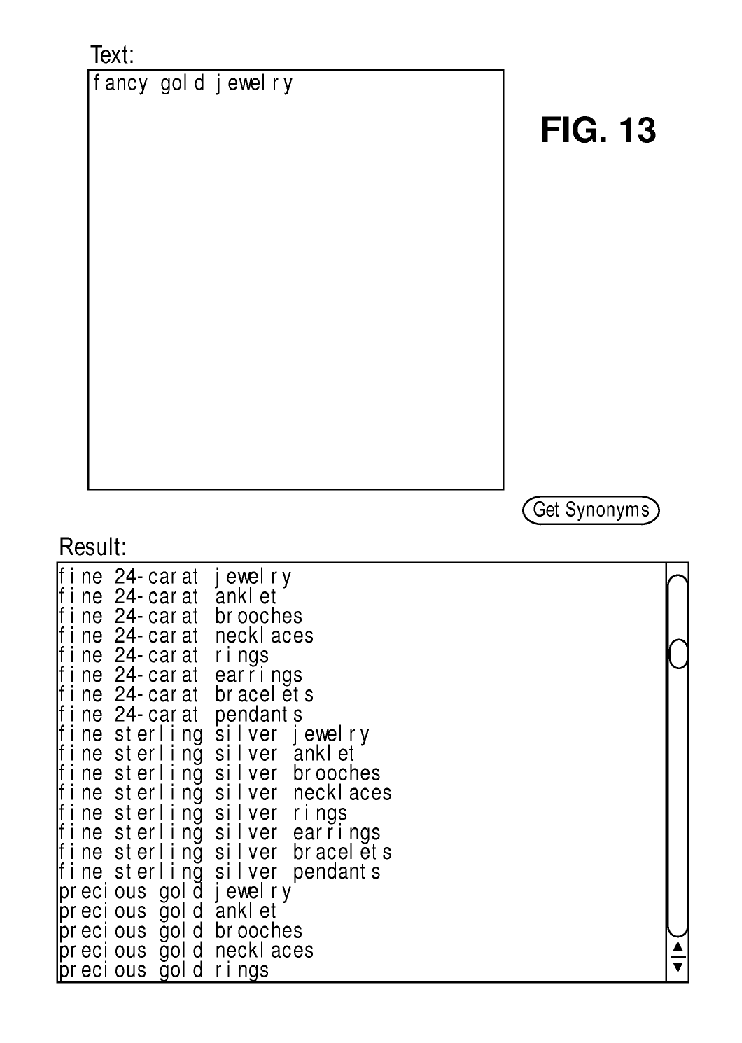

A keyword builder 450 looks at all the words in all the queries and finds any synonyms from a synonym database 452. A permutation engine 454 combines each word's synonyms with each other word's synonyms. The permutations are then used as the keywords for the search engine marketing campaign. A high probability of having a large volume of keywords in the campaign that are extremely relevant to the listing is so provided, which yields a better Click-Through-Rate and a higher Quality Score. FIG. 13 shows a screen shot of the synonym discovery system. A text box is provided for entry of a keyword or a keyword phrase. A results window is provided to display synonyms for the keyword or keyword phrase.

A generation module 500 is connected to the good products 402, the tracking database 410, the crawler target store 24 and the keyword database 442. The generation module 500 thus includes modules to communicate with the good products 402, the tracking database 410, the crawler target store 24 and the keyword database 442. As mentioned, the generation module 500 relies on the tracking database 410 to track client feedback. The generation module 500 also extracts keywords from the keyword database 442 and backfills the extracted keywords into the representations that are submitted to the crawler target store 24.

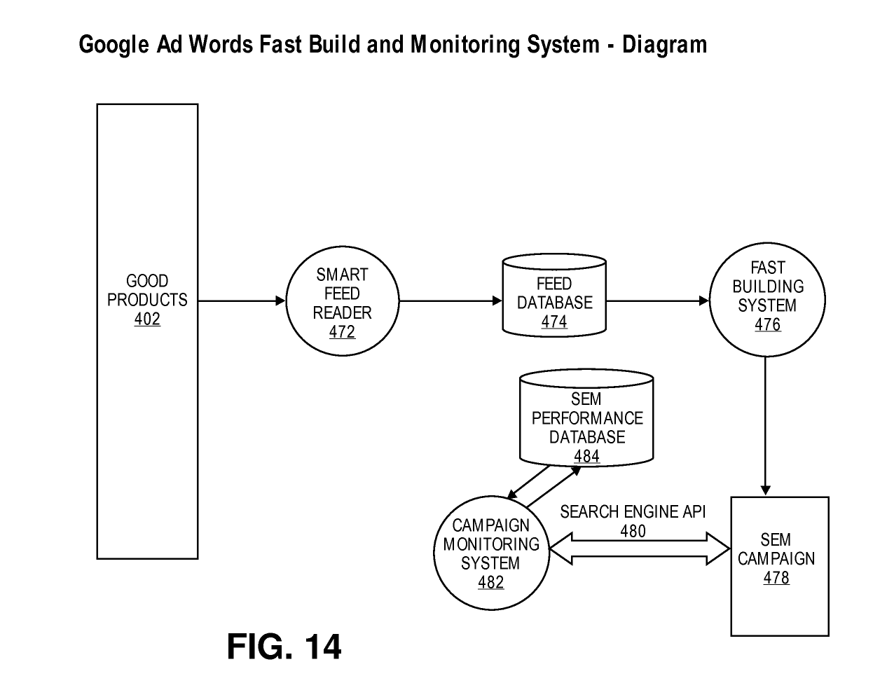

FIG. 14 shows a fast building and monitoring system that is designed to create a search engine marketing campaign 478 quickly and automatically. A campaign 478 consists of a number of ad groups, each of which has a number of keywords and ads associated with it. Each ad consists of a title and a description. The customer has a list of good products 402 that they make available on a web server. The fast building system 476 uses a template to combine information from the list of good products 402 with predetermined patterns for keywords, ad titles, and descriptions. The fast building system 476 generates a spreadsheet that can be uploaded to a search engine to create the campaign 478.

A smart feed reader 472 retrieves the list of good products 402 each day and stores any changes from the previous day in a feed database 474. A fast building system 476 reads the feed database 474 each day to get any changes that the customer may have made.

If a listing has been dropped from the customer's list of products 402 a campaign monitoring system 482 pauses all ad groups pertaining to the listing in the campaign, using the search engine's application protocol interface (API) 480.

For each active ad group, the campaign monitoring system 482 accesses a search engine marketing performance database 484 to determine what the performance of that ad group has been. If the ad group has received X number of clicks and has a Return On Ad Spend (ROAS) less than Y, the ad group is paused in the search engine marketing campaign using the search engine's API 480.

Similarly, for each active keyword, the campaign monitoring system 482 looks in the search engine marketing performance database 484 to see what the performance of that keyword has been. If the keyword has received X number of clicks and has a Return On Ad Spend (ROAS) less than Y, the keyword is paused in the search engine marketing campaign using the search engine's API 480.

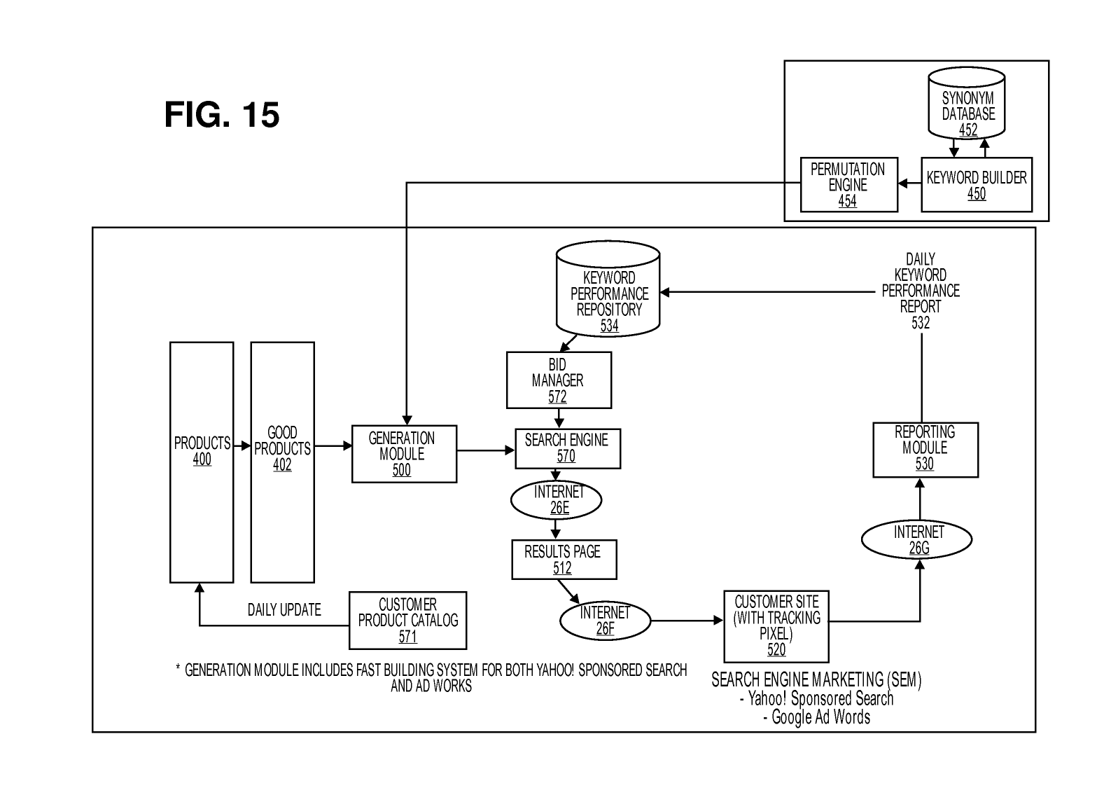

FIG. 15 shows components of the system for a search engine marketing campaign that is integrated with the components in FIG. 13 for paid inclusion.

The search engine marketing system of FIG. 15 includes a generation module 500 that receives the keywords from the permutation engine 454. The generation module 500 also includes search engine marketing links from the good products 402. The generation module then combines the keywords with the links so that each link has a respective set of associated keywords. The generation module 500 then transmits the combinations to the search engine 570. A deep-linked search engine marketing campaign is thereby created for the search engine 570.

As described hereinbefore with the respect to FIGS. 1 to 10, web pages are stored at a plurality of web page locations. For a search engine marketing campaign, the respective web pages are product web pages located at one or more customer sites. A search request is transmitted from a client location connected over the Internet to the search engine 570. The search engine 570 utilizes the search request to extract one or more links to the web pages by comparing the search request to the keywords. Search engine marketing links normally have a preferred location on a results page when compared to links for an organic search.

The search engine 570 then transmits a results page 512 over the Internet 26E to the client location. The results page 512 includes one or more search result links that are extracted by the search engine 570. The user can select one of the links and be connected over the Internet 26F to a customer site 520. The customer site 520 has a tracking pixel that reports user actions over the Internet 26G to a reporting module 530. The reporting module 530 collects all user actions. The reporting module 530 transmits a daily keyword performance report 532 of the user actions to a keyword performance repository 534. A bid manager 572 is connected to the keyword performance repository 534. The bid manager 572 is used to generate bids based on keyword performance as evidenced in the keyword performance repository 534, and submits the bids to the search engine 570.

Further details of the search engine marketing system 15 are similar to the paid inclusion system described with reference to FIGS. 1 to 10 and are therefore not repeated herein in detail.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of providing information over a network, comprising:
creating combined information by combining information from a list of product web pages and links to the products with predetermined patterns for keywords, ad titles, and descriptions;
and uploading the combined information to the search engine to create the campaign for the links, wherein the web pages are stored at a plurality of web page locations, a search request transmitted from a client location connected over the network to the search engine being utilized at the search engine to extract at least one of the links of the web pages from a search database connected to the search engine, and the search engine transmitting at least one search result link to the client location, the search result link being based on the search request and the search result link being utilized at the client location to transmit a request for the web page over the network such that the web page is transmitted from the web page location to the client location in response to the request from the client location for the web page.

2. The method of claim 1, further comprising:
preparing a paid inclusion representation of a web page;
and providing the paid inclusion representation to a search engine.

3. The method of claim 1, further comprising:
extracting a synonym for each of a plurality of keywords;
associating each synonym with a respective one of a set of links;
and transmitting the synonyms to the search engine for association with the links as a search engine marketing campaign.

4. The method of claim 1, further comprising:
using a template to combine the information from the list of good products with predetermined patterns for keywords, ad titles, and descriptions.

5. The method of claim 1, wherein the combination is in the form of a spreadsheet that is uploaded to a search engine to create the campaign.

6. The method of claim 1, further comprising:
periodically retrieving the list of good products and storing any changes.

7. The method of claim 6, further comprising:
if a listing has been dropped from the list of products, pausing all ad groups pertaining to the listing in the campaign.

8. The method of claim 7, wherein, for each active ad group, if the ad group has received X number of clicks and has a Return On Ad Spend (ROAS) less than Y, the ad group is paused in the search engine marketing campaign.

9. The method of claim 7, wherein, for each active keyword, if the keyword has received X number of clicks and has a Return On Ad Spend (ROAS) less than Y, the keyword is paused in the search engine marketing campaign.

10. The method of claim 1, further comprising:
receiving at least one tracking signal indicative of use at the client location of at least some of the web pages in the list;
and transmitting a second list of web pages to the search engine, the second list being a subset of web pages, the subset being selected based on the tracking signals.

11. A computer-readable medium having stored thereon a set of instructions that is executable by a processor of at least one computer to provide information over a network according to a method of providing information over a network, comprising:
creating combined information by combining information from a list of product web pages and links to the products with predetermined patterns for keywords, ad titles, and descriptions;
and uploading the combined information to the search engine to create the campaign for the links, wherein the web pages are stored at a plurality of web page locations, a search request transmitted from a client location connected over the network to the search engine being utilized at the search engine to extract at least one of the links of the web pages from a search database connected to the search engine, and the search engine transmitting at least one search result link to the client location, the search result link being based on the search request and the search result link being utilized at the client location to transmit a request for the web page over the network such that the web page is transmitted from the web page location to the client location in response to the request from the client location for the web page.

12. A method of providing information over a network, comprising:
storing a plurality of product web pages at a plurality of web page locations;
creating combined information by combining information from a list of product web pages and links to the products with predetermined patterns for keywords, ad titles, and descriptions;
and uploading the combined information to the search engine to create the campaign for the links, wherein the web pages are stored at a plurality of web page locations, a search request transmitted from a client location connected over the network to the search engine being utilized at the search engine to extract at least one of the links of the web pages from a search database connected to the search engine, and the search engine transmitting at least one search result link to the client location, the search result link being based on the search request and the search result link being utilized at the client location to transmit a request for the web page over the network such that the web page is transmitted from the web page location to the client location in response to the request from the client location for the web page;
transmitting a search request from a client location connected over the network to the search engine;
utilizing the search request at the search engine to extract at least one of the representations of the web pages;
transmitting at least one search result link from the search engine to the client location, the search result link being based on the representation for the web page that is extracted;
utilizing the search result link at the client location to transmit a request for the web page over the network;
and transmitting the web page from the web page location to the client location in response to the request from the client location for the web page.

13. A computer system for providing information over a network, comprising:
a search engine marketing system which includes:
a module to create combined information by combining information from a list of product web pages and links to the products with predetermined patterns for keywords, ad titles, and descriptions, and uploading the combined information to the search engine to create the campaign for the links, wherein the web pages are stored at a plurality of web page locations, a search request transmitted from a client location connected over the network to the search engine being utilized at the search engine to extract at least one of the links of the web pages from a search database connected to the search engine, and the search engine transmitting at least one search result link to the client location, the search result link being based on the search request and the search result link being utilized at the client location to transmit a request for the web page over the network such that the web page is transmitted from the web page location to the client location in response to the request from the client location for the web page.

14. The computer system of claim 13, further comprising:
a paid inclusion system which includes:
a module to create a representation of a website;
a module to store the representation at a representation location;
a module to transmit a crawling link to the search engine, the crawling link being utilized by a crawler to access and copy the representation from the representation location to the search database, to provide the representation to a search engine;
a feed reader receiving a tracking signal indicative of use at the client location of at least some of the web pages in the list, the feed reader transmitting a second list of web pages to the search engine, the second list being a subset of web pages, the subset being selected based on the tracking signals.

15. The computer system of claim 13, further comprising:
a keyword builder extracting a synonym for each of a plurality of keywords;
a generation module associating each synonym with a respective one of a set of links;
and a transmission module transmitting the synonyms to the search engine for association with the links.

16. The computer system of claim 13, wherein the building system uses a template to combine the information from the list of good products with predetermined patterns for keywords, ad titles, and descriptions.

17. The computer system of claim 13, wherein the combination is in the form of a spreadsheet that is uploaded to a search engine to create the campaign.

18. The computer system of claim 13, further comprising:
a campaign monitoring system that periodically retrieves the list of good products and stores any changes.

19. The computer system of claim 17, further comprising:
if a listing has been dropped from the list of products, pausing all ad groups pertaining to the listing in the campaign.

20. The computer system of claim 19, wherein, for each active ad group, if the ad group has received X number of clicks and has a Return On Ad Spend (ROAS) less than Y, the ad group is paused in the search engine marketing campaign.
